(19) United States
(12) Patent Application Publication
(10) Pub. No.: US 2026/0111516 A1
(43) Pub. Date: Apr. 23, 2026

(54) COMMON PIPELINE NON-LINEAR TRANSFORMATION

(71) Applicant: EDGECORTIX INC., Tokyo (JP)

(72) Inventors: Anudeep CHERLAPALLY, Tokyo (JP); Oleg KHAVIN, Tokyo (JP); Nikolay NEZ, Tokyo (JP); Antonio Tomas Nevado VILCHEZ, Tokyo (JP); Pablo QUINTANA, Bueu (ES); Sakyasingha DASGUPTA, Tokyo (JP)

(21) Appl. No.: 18/918,057

(22) Filed: Oct. 17, 2024

(51) Int. Cl. G06F 17/17; G06F 1/03; G06F 7/487

(52) U.S. Cl. CPC G06F 17/17; G06F 1/03; G06F 7/4876

(57) ABSTRACT

Common pipeline non-linear transformation is implemented by a non-linear transformation pipeline configured to perform a plurality of non-linear functions including extracting, from an input floating point value, a fractional component and a real component, applying, to the fractional component, a linear approximator corresponding to one non-linear function among the plurality of non-linear functions to obtain an approximate value, and multiplying the approximate value by the real component to produce a transformed floating point value, a memory in communication with the non-linear transformation pipeline, and a controller configured to transmit the input floating point value from the memory to the non-linear transformation pipeline, configure the non-linear transformation pipeline for the one non-linear function among the plurality of non-linear functions, and store the transformed floating point value on the memory.

### BACKGROUND

Non-linear transformations are commonly used in performing inference of neural networks. Non-linear transformations are utilized in attention functions in transformer neural network architecture, such as in Generative Pretrained Transformer (GPT) architecture, and in activation functions in convolutional neural network (CNN) architecture. Examples of types of non-linear transformations include exponent, reciprocal, square-root, and other non-linear calculations, or combinations thereof, such as Softmax, variance, Root Mean Square (RMS), etc.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for common pipeline non-linear transformation, according to at least some embodiments of the subject disclosure.

FIG. 2 is a schematic diagram of a non-linear transformation pipeline, according to at least some embodiments of the subject disclosure.

FIG. 3 is a schematic diagram of an exponent function, according to at least some embodiments of the subject disclosure.

FIG. 4 is a schematic diagram of a square-root function, according to at least some embodiments of the subject disclosure.

FIG. 5 is a schematic diagram of an inversion function, according to at least some embodiments of the subject disclosure.

FIG. 6 is an operational flow for common pipeline non-linear transformation, according to at least some embodiments of the subject disclosure.

FIG. 7 is an operational flow for performing a non-linear transformation, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

In accelerator chips known to the inventors, each type of non-linear transformation is performed by a separate portion of chip hardware. More specifically, values that undergo non-linear transformation are routed to a portion of the chip dedicated to that type of non-linear transformation. Furthermore, only one type of non-linear transformation is performed at a given time. Thus, non-linear transformation chip hardware lowers the average resource usage by the chip.

In at least some embodiments of the subject disclosure, non-linear transformations are broken down into core non-linear calculations, and performed on floating point values. Many non-linear transformations involve common non-linear calculations in unique combinations according to the function. In at least some embodiments, an integrated circuit chip includes a common pipeline for multiple types of non-linear transformations. In at least some embodiments, the common pipeline includes overlapping components utilized for core non-linear calculations. In at least some embodiments, the core non-linear calculations use overlapping components to separate a fractional component from a real component. In at least some embodiments, a common linear approximator is utilized to perform any of multiple non-linear calculations on the fractional component, by referring to a unique linear equation or Look-Up Table (LUT). In at least some embodiments, core non-linear calculations are uniquely combined by adding, multiplying, etc. to realize more complex non-linear transformations.

In at least some embodiments, reuse of the common components in the common pipeline to perform non-linear transformations yields greater efficiency and greater average resource usage. In at least some embodiments, the common pipeline includes conversions between number formats for compatibility with integer and floating point values. In at least some embodiments, resulting floating point values are selectively converted to a non-floating point value, or maintained as a floating point value. The conversion, or lack thereof, occurs between computations or storage to cause some layers to be inferred in a greater range and granularity while other layers are inferred in a lesser range and granularity.

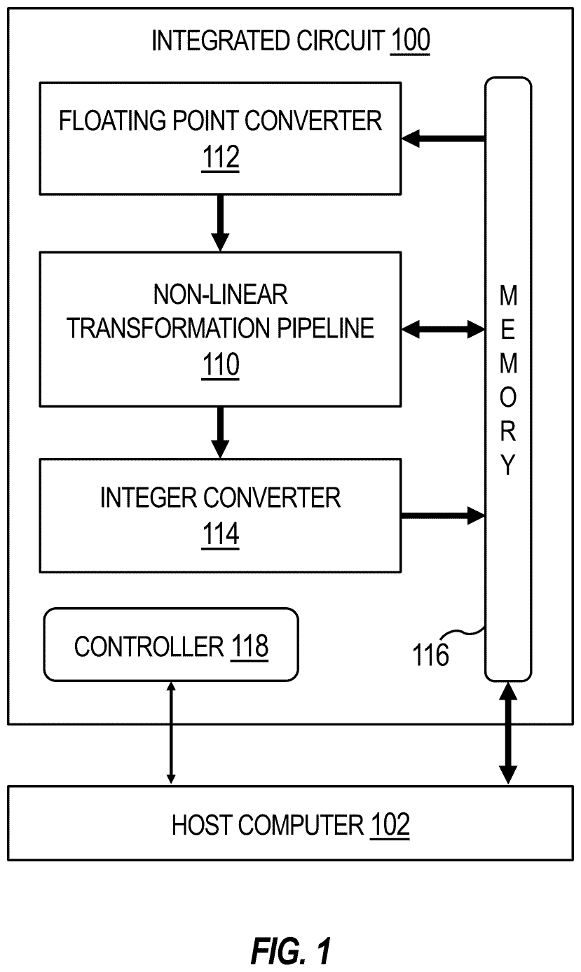

FIG. 1 is a schematic diagram of a system for common pipeline non-linear transformation, according to at least some embodiments of the subject disclosure. The system for common pipeline non-linear transformation includes integrated circuit 100, host computer 102, non-linear transformation pipeline 110, floating point converter 112, integer converter 114, memory 116, and controller 118.

In at least some embodiments, integrated circuit 100 is configured to house non-linear transformation pipeline and other components. In at least some embodiments, integrated circuit 100 is configured for neural network inference. In at least some embodiments, integrated circuit 100 is configured to interface with host computer 102. In at least some embodiments, integrated circuit 100 is in the form of a microchip, an ASIC (Application-Specific Integrated Circuit), an FPGA (Field-Programmable Gate Array), or any other form of integrated circuitry. In at least some embodiments, integrated circuit 100 is of the type used in various electronic devices, from smartphones to industrial machinery.

In at least some embodiments, host computer 102 is configured to provide the interface for configuring and controlling integrated circuit 100. In at least some embodiments, host computer 102 is configured to communicate with integrated circuit 100 to transmit and receive data and control signals. In at least some embodiments, host computer 102 is configured to communicate with integrated circuit 100 through a direct connection, a network, a wide area network, or any other form of electronic communication. In at least some embodiments, host computer 102 is further configured to handle general computing tasks, running applications, and data processing. In at least some embodiments, host computer 102 is configured to interface with peripherals like keyboards, monitors, and external storage devices. In at least some embodiments, host computer 102 is in the form of a desktop computer, a laptop computer, a server, etc. In at least some embodiments, host computer 102 is of the type used in offices, homes, and data centers for a wide range of computing tasks.

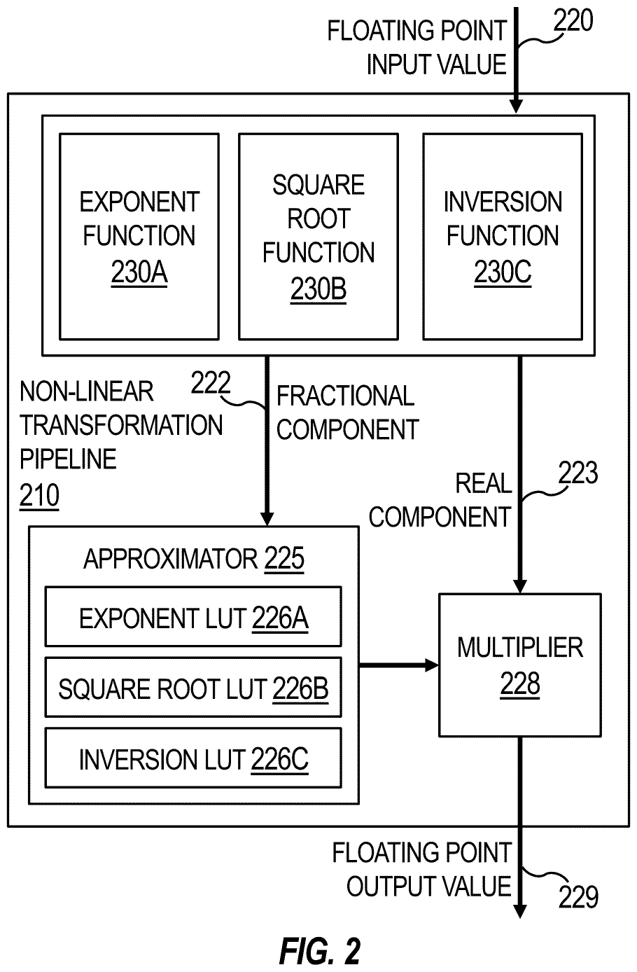

Non-linear transformation pipeline 110 is a component of integrated circuit 100. In at least some embodiments, non-linear transformation pipeline 110 is configured to perform a variety of non-linear transformations on floating point values. In at least some embodiments, non-linear transformation pipeline 110 is configured to receive input values from memory 116 and floating point converter 112. In at least some embodiments, non-linear transformation pipeline 110 is configured to transmit transformed values to memory 116. In at least some embodiments, non-linear transformation pipeline 110 includes dedicated circuitry configured for non-linear transformations. In at least some embodiments, non-linear transformation pipeline 110 is implemented as a series of logic gates and registers. In at least some embodiments, non-linear transformation pipeline 110 is as shown in FIG. 2, described hereinafter. In at least some embodiments, a non-linear transformation pipeline includes an extractor configured to extract, from an input floating point value, a fractional component and a real component, an approximator configured to apply, to the fractional component, a linear approximator corresponding to one non-linear function among the plurality of non-linear functions to obtain an approximate value, and a multiplier configured to multiply the approximate value by the real component to produce a transformed floating point value. In at least some embodiments, the plurality of non-linear functions include an exponential function, a square root function, and an inversion function. In at least some embodiments, such non-linear functions can be combined to form more complex non-linear transformations. In at least some embodiments, the plurality of non-linear functions further include Sigmoid functions, Gelu functions, ReLU functions, etc.

Floating point converter 112 is a component of integrated circuit 100. In at least some embodiments, floating point converter 112 is configured to convert integer values to floating point values for processing in non-linear transformation pipeline 110. In at least some embodiments, floating point converter 112 is configured to receive integer values from memory 116. In at least some embodiments, floating point converter 112 is configured to transmit floating point values to non-linear transformation pipeline 110. In at least some embodiments, floating point converter 112 is configured to transmit floating point values to memory 116. In at least some embodiments, floating point converter 112 is configured to perform conversion from various integer formats to various floating point formats. In at least some embodiments, floating point converter 112 is configured to interact with other components of integrated circuit 100 requiring numerical conversions. In at least some embodiments, floating point converter 112 is implemented as a series of logic gates and registers. In at least some embodiments, floating point converter 112 is configured to convert an input integer value into the input floating point value.

Integer converter 114 is a component of integrated circuit 100. In at least some embodiments, integer converter 114 is configured to convert floating point values to integer values. In at least some embodiments, integer converter 114 is configured to receive floating point values from non-linear transformation pipeline 110. In at least some embodiments, integer converter 114 is configured to receive floating point values from memory 116. In at least some embodiments, integer converter 114 is configured to transmit integer values to memory 116. In at least some embodiments, integer converter 114 is configured to perform conversion from various floating point formats to various integer formats. In at least some embodiments, integer converter 114 is configured to interact with other components of integrated circuit 100 requiring numerical conversions. In at least some embodiments, integer converter 114 is implemented as a series of logic gates and registers. In at least some embodiments, integer converter 114 is configured to convert the transformed floating point value into a transformed integer value.

Memory 116 is a component of integrated circuit 100. In at least some embodiments, memory 116 is configured to store input values, intermediate results, and final transformed values. In at least some embodiments, memory 116 is configured to interface with controller 118, non-linear transformation pipeline 110, floating point converter 112, and integer converter 114. In at least some embodiments, memory 116 is in communication with the non-linear transformation pipeline. In at least some embodiments, memory 116 is configured to provide general data storage for various applications. In at least some embodiments, memory 116 is in the form of RAM (Random Access Memory), flash memory, or any other form of on-chip memory.

Controller 118 is a component of integrated circuit 100. In at least some embodiments, controller 118 is configured to manage the flow of data and control signals within the system. In at least some embodiments, controller 118 is configured to configure non-linear transformation pipeline 110. In at least some embodiments, controller 118 is configured to transmit control signals and otherwise communicate with memory 116, non-linear transformation pipeline 110, floating point converter 112, and integer converter 114. In at least some embodiments, controller 118 is configured to interface with host computer 102. In at least some embodiments, controller 118 is in the form of a microcontroller, one or more control units, or any other type of controller used within integrated circuits. In at least some embodiments, controller 118 is configured to transmit the input floating point value from the memory to the non-linear transformation pipeline, configure the non-linear transformation pipeline for the one non-linear function among the plurality of non-linear functions, and store the transformed floating point value on the memory. In at least some embodiments, controller 118 is configured to transmit the input integer from the memory to the floating point converter, and transmit the input floating point value from the floating point converter to the non-linear transformation pipeline. In at least some embodiments, controller 118 is configured to transmit the transformed floating point value from one of the non-linear transformation pipeline and the memory to the integer converter, and store the transformed integer value on the memory.

FIG. 2 is a schematic diagram of a non-linear transformation pipeline 210, according to at least some embodiments of the subject disclosure. Non-linear transformation pipeline 210 includes exponent function 230A, square-root function 230B, inversion function 230C, linear approximator 225, exponent LUT 226A, square-root LUT 226B, inversion LUT 226C, and multiplier 228. The descriptions of non-linear transformation pipeline 110 of FIG. 1 are applicable to non-linear transformation pipeline 210.

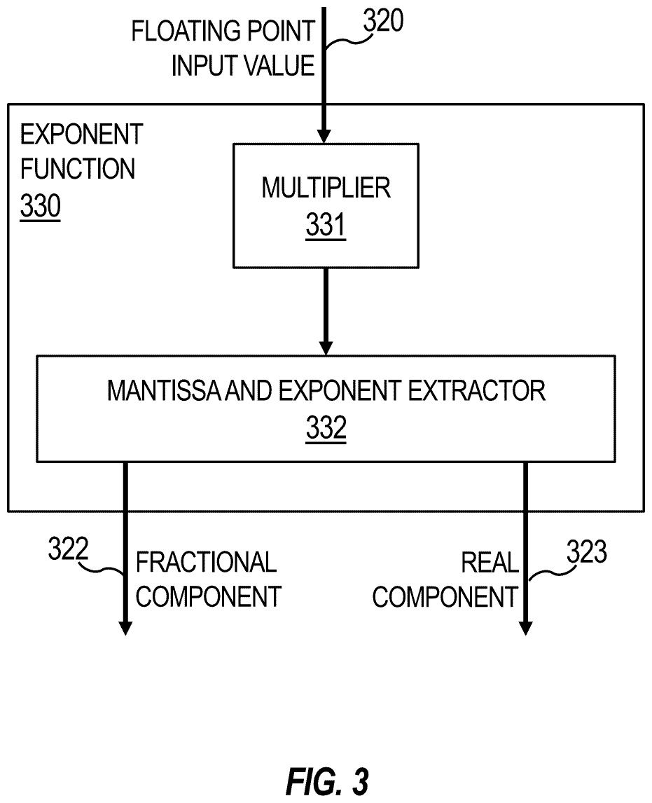

Exponent function 230A is a component of non-linear transformation pipeline 210. In at least some embodiments, exponent function 230A is configured to perform operations toward computing an exponential of input floating point values, such as input floating point value 220. In at least some embodiments, exponent function 230A is configured to apply one or more pre-extraction operations to input floating point values. In at least some embodiments, exponent function 230A is configured to extract fractional components, such as fractional component 222, and real components, such as real component 223, from input floating point values. In at least some embodiments, exponent function 230A is configured to apply one or more post-extraction operations to extracted fractional components and real components. In at least some embodiments, exponent function 230A is configured to transmit fractional components to linear approximator 225. In at least some embodiments, exponent function 230A is configured to transmit real components, such as real component 223, to multiplier 228. In at least some embodiments, exponent function 230A is as shown in FIG. 3, described hereinafter.

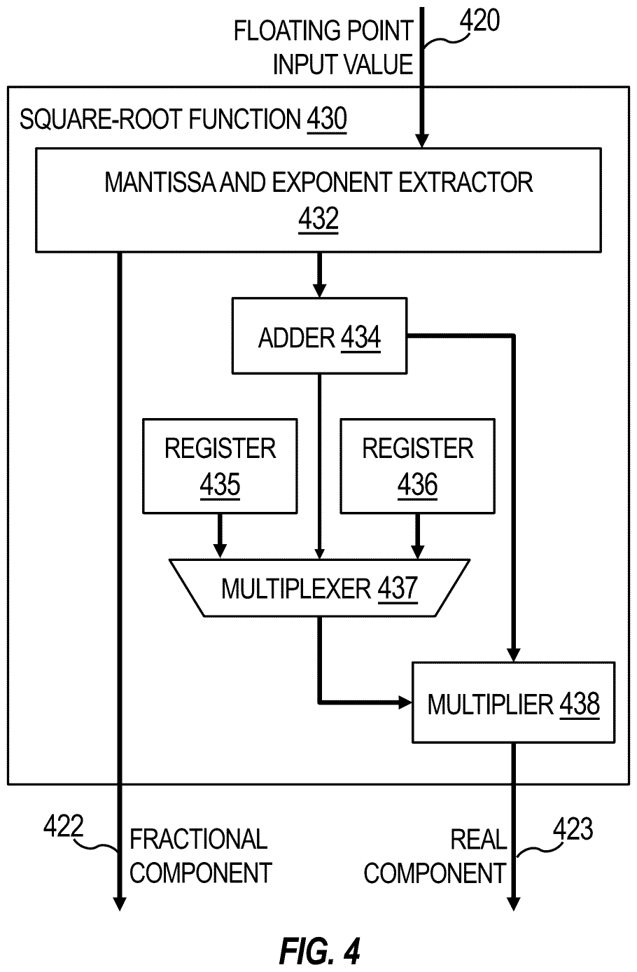

Square-root function 230B is a component of non-linear transformation pipeline 210. In at least some embodiments, square-root function 230B is configured to perform operations toward computing a square root of input floating point values, such as input floating point value 220. In at least some embodiments, square-root function 230B is configured to apply one or more pre-extraction operations to input floating point values. In at least some embodiments, square-root function 230B is configured to extract fractional components, such as fractional component 222, and real components, such as real component 223, from input floating point values. In at least some embodiments, square-root function 230B is configured to apply one or more post-extraction operations to extracted fractional components and real components. In at least some embodiments, square-root function 230B is configured to transmit fractional components to linear approximator 225. In at least some embodiments, square-root function 230B is configured to transmit real components, such as real component 223, to multiplier 228. In at least some embodiments, square-root function 230B is as shown in FIG. 4, described hereinafter.

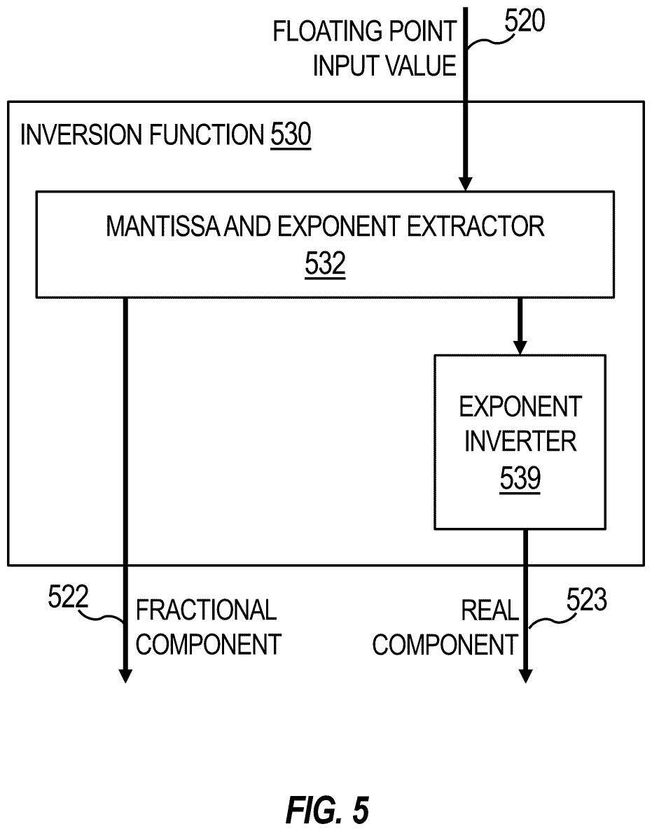

Inversion function 230C is a component of non-linear transformation pipeline 210. In at least some embodiments, inversion function 230C is configured to perform operations toward computing an inverse of input floating point values, such as input floating point value 220. In at least some embodiments, inversion function 230C is configured to apply one or more pre-extraction operations to input floating point values. In at least some embodiments, inversion function 230C is configured to extract fractional components, such as fractional component 222, and real components, such as real component 223, from input floating point values. In at least some embodiments, inversion function 230C is configured to apply one or more post-extraction operations to extracted fractional components and real components. In at least some embodiments, inversion function 230C is configured to transmit fractional components to linear approximator 225. In at least some embodiments, inversion function 230C is configured to transmit real components, such as real component 223, to multiplier 228. In at least some embodiments, inversion function 230C is as shown in FIG. 5, described hereinafter.

In at least some embodiments, exponent function 230A, square-root function 230B, and inversion function 230C share one or components for performing operations toward respective computations. In at least some embodiments, non-linear transformation pipeline 210 further includes at least one pre-extraction transformer, at least one fractional component transformer, and at least one real component transformer.

Linear approximator 225 is a component of non-linear transformation pipeline 210. In at least some embodiments, linear approximator 225 is configured to produce linear approximations of non-linear functions applied to fractional components, such as fractional component 222. In at least some embodiments, linear approximator 225 utilizes linear functions that are approximations of non-linear functions. In at least some embodiments, linear approximator 225 includes a Look-Up Table (LUT). In at least some embodiments, linear approximator 225 utilizes LUTs for different functions, such as exponent LUT 226A, square root LUT 226B, and inversion LUT 226C. Each LUT utilized by linear approximator 225 matches an input value with an output value according to an approximation of a non-linear function. In at least some embodiments, linear approximator 225 is configured to receive fractional components from one of exponent function 230A, square-root function 230B, and inversion function 230C. In at least some embodiments, linear approximator 225 is configured to transmit approximated values to multiplier 228. In at least some embodiments, linear approximator 225 is configured to perform linear interpolation.

Multiplier 228 is a component of non-linear transformation pipeline 210. In at least some embodiments, multiplier 228 is configured to multiply approximate values from linear approximator 225 by real components, such as real component 223, to produce transformed floating point values, such as floating point output value 229. In at least some embodiments, multiplier 228 is configured to receive real components from one of exponent function 230A, square-root function 230B, and inversion function 230C. In at least some embodiments, multiplier 228 is configured to perform floating point multiplication operations on floating point values. In at least some embodiments, multiplier 228 is of a type commonly implemented in integrated circuits, ASICs, or FPGAs.

FIG. 3 is a schematic diagram of an exponent function 330, according to at least some embodiments of the subject disclosure. The exponent function 330 includes multiplier 331, mantissa and exponent extractor 332, floating point input value 320, fractional component 322, and real component 323. The descriptions of exponent function 230A of FIG. 2 are applicable to exponent function 330.

Multiplier 331 is a component of exponent function 330. In at least some embodiments, multiplier 331 is configured to apply a pre-extraction operation as part of computing an exponential of input floating point values, such as floating point input value 320. In at least some embodiments, multiplier 331 is configured to multiply floating point input values by a predetermined value to produce a product value. In at least some embodiments, multiplier 331 is configured to multiply input floating point values by an approximation of the inverse of the natural log of 2. In at least some embodiments, multiplier 331 is configured to transmit the product value to mantissa and exponent extractor 332. In at least some embodiments, multiplier 331 is shared among exponent function 330 and other functions, such as one or more of square-root function 230B and inversion function 230C of FIG. 2. In at least some embodiments, multiplier 331 is configured to apply a pre-extraction operation as part of other non-linear functions. In at least some embodiments, multiplier 331 is a pre-extraction transformer. In at least some embodiments, wherein the one non-linear function is an exponential function, the pre-extraction transformer includes a pre-extraction multiplier configured to multiply the input floating point value by an approximation of an inverse of a natural log of 2.

Mantissa and exponent extractor 332 is a component of exponent function 330. In at least some embodiments, mantissa and exponent extractor 332 is configured to extract mantissa data and exponent data from a floating point input value, such as floating point input value 320. In at least some embodiments, mantissa and exponent extractor 332 is configured to convert mantissa data into a fractional component, such as fractional component 322, and exponent data into a real component, such as real component 323. In at least some embodiments, mantissa and exponent extractor 332 is configured to produce a fractional component as a floating point value. In at least some embodiments, mantissa and exponent extractor 332 is configured to produce a real component as a floating point value. In at least some embodiments, mantissa and exponent extractor 332 is shared among exponent function 330 and other functions, such as one or more of square-root function 230B and inversion function 230C of FIG. 2. In at least some embodiments, mantissa and exponent extractor 332 is configured to extract mantissa data and exponent data as part of other non-linear functions or other processes of a non-linear transformation pipeline.

FIG. 4 is a schematic diagram of a square-root function 430, according to at least some embodiments of the subject disclosure. Square-root function 430 includes mantissa and exponent extractor 432, adder 434, register 435, register 436, multiplexer 437, multiplier 438, floating point input value 420, fractional component 422, and real component 423. The descriptions of square-root function 230B of FIG. 2 are applicable to square-root function 430. The descriptions of mantissa and exponent extractor 332 of FIG. 3 are applicable to mantissa and exponent extractor 432.

Adder 434 is a component of square-root function 430. In at least some embodiments, adder 434 is configured to apply a post-extraction operation as part of a square root calculation process. In at least some embodiments, adder 434 is configured to receive exponent data from mantissa and exponent extractor 432. In at least some embodiments, adder 434 is configured to perform a general addition operation. In at least some embodiments, adder 434 is configured to add exponent data to a predetermined value to produce a sum value. In at least some embodiments, adder 434 is configured to transmit the sum value to multiplier 438. In at least some embodiments, adder 434 is configured to determine whether the sum value is even or odd. In at least some embodiments, adder 434 utilizes a modulus operator to determine whether the sum value is even or odd. In at least some embodiments, adder 434 is configured to control an input of multiplexer 437 according to whether the sum value is even or odd. In at least some embodiments, adder 434 is shared among square-root function 430 and other functions, such as one or more of exponent function 230A and inversion function 230C of FIG. 2. In at least some embodiments, adder 434 is configured to perform addition operations as part of other non-linear functions or other processes of a non-linear transformation pipeline.

Register 435 and register 436 are components of square-root function 430. In at least some embodiments, register 435 and register 436 are configured to store predetermined values for use in square root calculation. In at least some embodiments, register 435 and register 436 are configured to transmit stored values to multiplier 438 via multiplexer 437. In at least some embodiments, register 435 and register 436 are configured to interact with other registers and memory in an integrated circuit, such as to receive predetermined values for storage.

Multiplexer 437 is a component of square-root function 430. In at least some embodiments, multiplexer 437 is configured to route one of multiple values to multiplier 438 as part of a square root calculation process. In at least some embodiments, multiplexer 437 is configured to receive values from registers 435 and 436. In at least some embodiments, multiplexer 437 is configured to direct one of the values from registers 435 and 436 to multiplier 438. In at least some embodiments, multiplexer 437 is configured to receive a control signal from adder 434 for selecting one of the values from registers 435 and 436. In at least some embodiments, multiplexer 437 is of a type commonly found in digital circuits and processors. In at least some embodiments, multiplexer 437 is shared among square-root function 430 and other functions, such as one or more of exponent function 230A and inversion function 230C of FIG. 2. In at least some embodiments, multiplexer 437 is configured to route one of multiple values as part of other non-linear functions or other processes of a non-linear transformation pipeline.

Multiplier 438 is a component of square-root function 430. In at least some embodiments, multiplier 438 is configured to multiply a sum value received from adder 434 by a value received from one of register 435 and register 436 via multiplexer 437 to produce a product value as part of a square root calculation process. In at least some embodiments, multiplier 438 is configured to multiply a sum value by a square root of 2 in response to determining that the sum value is even. In at least some embodiments, multiplier 438 is shared among square-root function 430 and other functions, such as one or more of exponent function 230A and inversion function 230C of FIG. 2. In at least some embodiments, multiplier 438 is configured to multiply values as part of other non-linear functions or other processes of a non-linear transformation pipeline.

In at least some embodiments, wherein the one non-linear function is a square root function, the real component transformer includes adder 434 configured to increase a value of the real component by 1, a modulus operator configured to apply a modulus 2 operation to the increased real component, multiplexer 437 configured to output a value of a square root of 2 in response to receiving a signal from the modulus operator representing an even result and a value of 1 in response to receiving a signal from the modulus operator not representing an even result, and a real component multiplier 438 configured to multiply the increased real component by the value output by multiplexer 437.

FIG. 5 is a schematic diagram of an inversion function 530, according to at least some embodiments of the subject disclosure. The inversion function 530 includes mantissa and exponent extractor 532, exponent inverter 539, floating point input value 520, fractional component 522, and real component 523. The descriptions of inversion function 230C of FIG. 2 are applicable to inversion function 530. The descriptions of mantissa and exponent extractor 332 of FIG. 3 are applicable to mantissa and exponent extractor 532.

Exponent inverter 539 is a component of inversion function 530. In at least some embodiments, exponent inverter 539 is configured to invert exponent data as part of an inversion calculation process. In at least some embodiments, exponent inverter 539 is configured to receive exponent data from mantissa and exponent extractor 532 and output inverted exponent data. In at least some embodiments, exponent inverter 539 is shared among inversion function 530 and other functions, such as one or more of exponent function 230A and square-root function 230B of FIG. 2. In at least some embodiments, exponent inverter 539 is configured to invert exponent data as part of other non-linear functions or other processes of a non-linear transformation pipeline. In at least some embodiments, Exponent inverter 539 is a real component transformer. In at least some embodiments, wherein the one non-linear function is an inversion function, the real component transformer includes an invertor for inverting the real component.

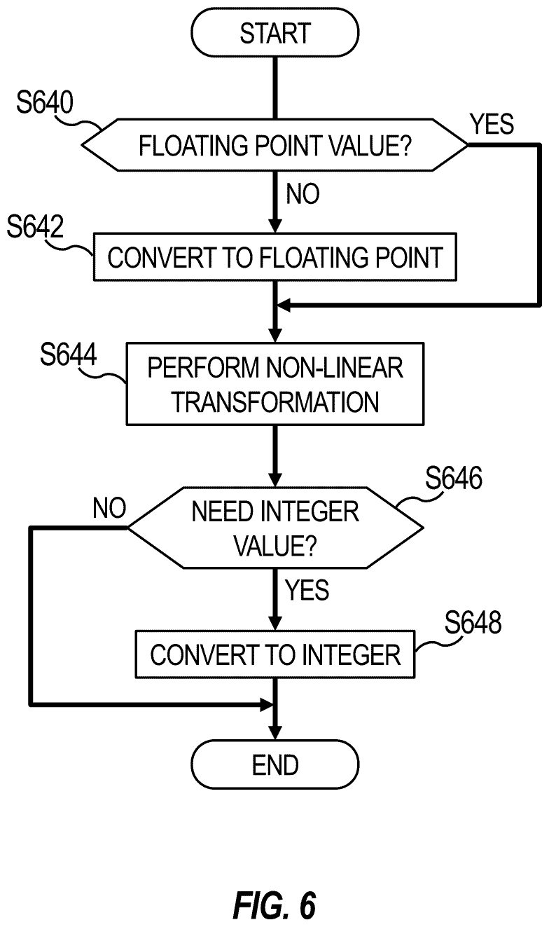

FIG. 6 is an operational flow for common pipeline non-linear transformation, according to at least some embodiments of the subject disclosure. In at least some embodiments, the operational flow provides a method of common pipeline non-linear transformation. In at least some embodiments, the method is performed by a controller of an integrated circuit, such as controller 118 of FIG. 1.

At S640, the controller determines whether a value is a floating point value. In response to determining that the value is not a floating point value, the operational flow proceeds to floating point conversion at S642. In response to determining that the value is a floating point value, the operational flow proceeds to non-linear transformation at S644.

At S642, the controller converts the value into a floating point format. In at least some embodiments, the controller converts an input integer value into a floating point format. In at least some embodiments, the controller instructs a floating point converter, such as floating point converter 112 of FIG. 1, to convert the value into a floating point format. In at least some embodiments, the value is an integer.

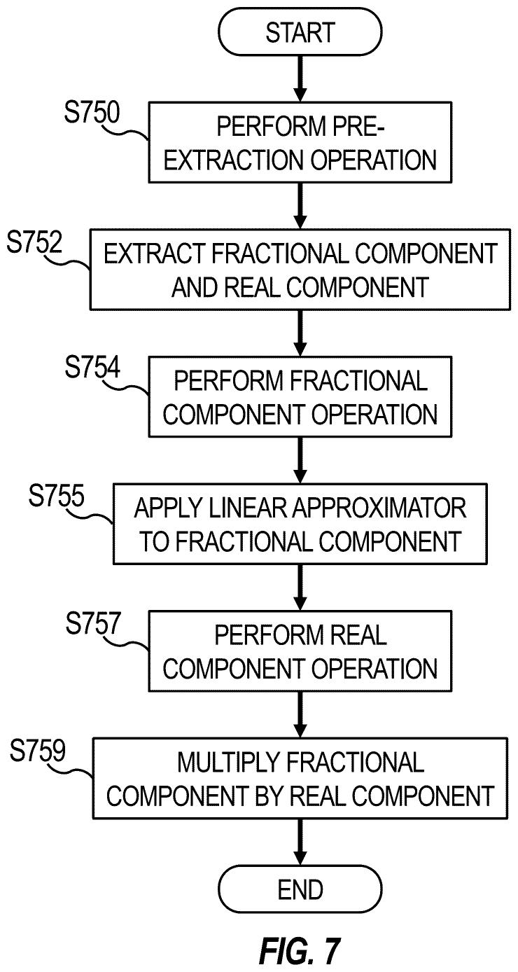

At S644, the controller performs a non-linear transformation. In at least some embodiments, the controller performs the non-linear transformation by extracting the fractional and real components from the floating point value. In at least some embodiments, the controller applies a linear approximator to the fractional component. In at least some embodiments, the controller multiplies the result by the real component. In at least some embodiments, the controller produces the transformed floating point value. In at least some embodiments, the controller performs the non-linear transformation based on a specified non-linear function. In at least some embodiments, the controller controls a common pipeline to perform the non-linear transformation. In at least some embodiments, the controller performs the operational flow of FIG. 7, described hereinafter.

At S646, the controller determines whether an integer value is needed. In response to determining that an integer value is needed, the operational flow proceeds to integer conversion at S648. In response to determining that an integer value is not needed, the operational flow ends. In at least some embodiments, the controller determines whether the transformed floating point value needs to be converted to an integer format to proceed with an inference process. In at least some embodiments, the controller determines whether the inference process requires an integer value or a floating point value. In at least some embodiments, the controller determines whether the inference process benefits from an integer value or a floating point value. In at least some embodiments, the controller makes the determination based on instructions from a host computer. In at least some embodiments, the controller applies an output format that meets the requirements of subsequent processes or applications.

At S648, the controller converts the transformed floating point value to an integer value. In at least some embodiments, the controller converts the transformed floating point value into an integer format. In at least some embodiments, the controller converts the transformed floating point value into a predetermined integer format.

FIG. 7 is an operational flow for performing a non-linear transformation, according to at least some embodiments of the subject disclosure. In at least some embodiments, the operational flow provides a method of performing a non-linear function. In at least some embodiments, the method is performed by a non-linear transformation pipeline of an integrated circuit, such as non-linear transformation pipeline 110 of FIG. 1.

At S750, the non-linear transformation pipeline or a sub-component thereof, performs a pre-extraction operation. In at least some embodiments, the non-linear transformation pipeline performs the pre-extraction operation according to the type of non-linear transformation. In at least some embodiments, a controller causes the non-linear transformation pipeline to perform the pre-extraction operation. In at least some embodiments, a controller configures the non-linear transformation pipeline for performance of the pre-extraction operation. In at least some embodiments, wherein the one non-linear function is an exponential function, the pre-extraction operation includes multiplying the input floating point value by an approximation of an inverse of a natural log of 2.

At S752, the non-linear transformation pipeline or a mantissa and exponent extractor thereof, extracts a fractional component and a real component. In at least some embodiments, the non-linear transformation pipeline extracts the fractional component and real component from mantissa data and exponent data of an input floating point value. In at least some embodiments, the controller causes the non-linear transformation pipeline to extract the fractional component and the real component. In at least some embodiments, the controller configures the non-linear transformation pipeline for extraction of the fractional component and the real component. In at least some embodiments, the non-linear transformation pipeline produces the fractional component and the real component in a floating point format.

At S754, the non-linear transformation pipeline or a sub-component thereof, performs a fractional component operation. In at least some embodiments, the non-linear transformation pipeline performs the fractional component operation by performing a post-extraction operation on the fractional component. In at least some embodiments, the controller causes the non-linear transformation pipeline to perform the fractional component operation. In at least some embodiments, the controller configures the non-linear transformation pipeline for performance of the fractional component operation. In at least some embodiments, the fractional component operation includes one or more of scaling, shifting, or other operations.

At S755, the non-linear transformation pipeline or a sub-component thereof, applies a linear approximator to the fractional component. In at least some embodiments, the non-linear transformation pipeline applies the linear approximator to the fractional component by using a linear approximator, such as a Look-Up Table (LUT), to approximate the value of the fractional component. In at least some embodiments, the linear approximator converts the input, which is in floating point format, into integer format for comparison with address values of the LUT. In at least some embodiments, the address values correspond indirectly to values A and B of the following formula:

$${F}_{O} = {F}_{I} * A + B$$

where F_{O} is the output fractional component, F_{I} is the input fractional component, and A and B are constants that are stored in the LUT. In at least some embodiments, the address values correspond directly to values of the output fractional component. In at least some embodiments, the linear approximator interpolates the values stored in the LUT that correspond to the address values nearest to the input integer value. In at least some embodiments, the non-linear transformation pipeline applies the linear approximator to the fractional component by using a linear approximator, such as a linear equation that approximates the fractional component. In at least some embodiments, the controller causes the non-linear transformation pipeline applies the linear approximator to the fractional component. In at least some embodiments, the controller configures the non-linear transformation pipeline for application of the linear approximator to the fractional component.

At S757, the non-linear transformation pipeline or a sub-component thereof, performs a real component operation. In at least some embodiments, the non-linear transformation pipeline performs the real component operation by performing a post-extraction operation on the real component. In at least some embodiments, the controller causes the non-linear transformation pipeline to perform the real component operation. In at least some embodiments, the controller configures the non-linear transformation pipeline for performance of the real component operation. In at least some embodiments, wherein the one non-linear function is an inversion function, the real component operation includes inverting the real component. In at least some embodiments, wherein the one non-linear function is a square root function, the real component operation includes increasing a value of the real component by 1, determining whether the increased real component is even, and multiplying the increased real component by the square root of 2 in response to determining that the increased real component is even.

At S759, the non-linear transformation pipeline or a multiplier thereof, multiplies the fractional component by the real component. In at least some embodiments, the non-linear transformation pipeline multiplies the fractional component by the real component by multiplying the approximated fractional component by the real component. In at least some embodiments, the non-linear transformation pipeline multiplies the fractional component in a floating point format by the real component in the floating point format. In at least some embodiments, the non-linear transformation pipeline produces a single floating point value that represents the result of the non-linear transformation.

While embodiments of the present invention have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

Common pipeline non-linear transformation is implemented by a non-linear transformation pipeline configured to perform a plurality of non-linear functions including extracting, from an input floating point value, a fractional component and a real component, applying, to the fractional component, a linear approximator corresponding to one non-linear function among the plurality of non-linear functions to obtain an approximate value, and multiplying the approximate value by the real component to produce a transformed floating point value, a memory in communication with the non-linear transformation pipeline, and a controller configured to transmit the input floating point value from the memory to the non-linear transformation pipeline, configure the non-linear transformation pipeline for the one non-linear function among the plurality of non-linear functions, and store the transformed floating point value on the memory.

In at least some embodiments, common pipeline non-linear transformation is further implemented by a floating point converter configured to convert an input integer value into the input floating point value, wherein the controller is further configured to transmit the input integer from the memory to the floating point converter, and transmit the input floating point value from the floating point converter to the non-linear transformation pipeline. In at least some embodiments, common pipeline non-linear transformation is further implemented by an integer converter configured to convert the transformed floating point value into a transformed integer value, wherein the controller is further configured to transmit the transformed floating point value from one of the non-linear transformation pipeline and the memory to the integer converter, and store the transformed integer value on the memory. In at least some embodiments, the plurality of non-linear functions include an exponential function, a square root function, and an inversion function. In at least some embodiments, the non-linear transformation pipeline is further configured to perform one or more of a pre-extraction operation, a fractional component operation, and a real component operation. In at least some embodiments, the one non-linear function is an exponential function, and the pre-extraction operation includes multiplying the input floating point value by an approximation of an inverse of a natural log of 2. In at least some embodiments, the one non-linear function is an inversion function, and the real component operation includes inverting the real component. In at least some embodiments, the one non-linear function is a square root function, and the real component operation includes increasing a value of the real component by 1, determining whether the increased real component is even, and multiplying the increased real component by the square root of 2 in response to determining that the increased real component is even. In at least some embodiments, the linear approximator includes a Look-Up Table (LUT).

Common pipeline non-linear transformation is implemented by a non-linear transformation pipeline including an extractor configured to extract, from an input floating point value, a fractional component and a real component, an approximator configured to apply, to the fractional component, a linear approximator corresponding to one non-linear function among the plurality of non-linear functions to obtain an approximate value, and a multiplier configured to multiply the approximate value by the real component to produce a transformed floating point value, a memory in communication with the non-linear transformation pipeline, and a controller configured to transmit the input floating point value from the memory to the non-linear transformation pipeline, configure the non-linear transformation pipeline for the one non-linear function among the plurality of non-linear functions, and store the transformed floating point value on the memory.

In at least some embodiments, common pipeline non-linear transformation is further implemented by a floating point converter configured to convert an input integer value into the input floating point value, wherein the controller is further configured to transmit the input integer from the memory to the floating point converter, and transmit the input floating point value from the floating point converter to the non-linear transformation pipeline. In at least some embodiments, common pipeline non-linear transformation is further implemented by an integer converter configured to convert the transformed floating point value into a transformed integer value, wherein the controller is further configured to transmit the transformed floating point value from one of the non-linear transformation pipeline and the memory to the integer converter, and store the transformed integer value on the memory. In at least some embodiments, the plurality of non-linear functions include an exponential function, a square root function, and an inversion function. In at least some embodiments, the non-linear transformation pipeline further includes at least one pre-extraction transformer, at least one fractional component transformer, and at least one real component transformer. In at least some embodiments, the one non-linear function is an exponential function, and the pre-extraction transformer includes a pre-extraction multiplier configured to multiply the input floating point value by an approximation of an inverse of a natural log of 2. In at least some embodiments, the one non-linear function is an inversion function, and the real component transformer includes an invertor for inverting the real component. In at least some embodiments, the one non-linear function is a square root function, and the real component transformer includes an adder configured to increase a value of the real component by 1, a modulus operator configured to apply a modulus 2 operation to the increased real component, a multiplexer configured to output a value of a square root of 2 in response to receiving a signal from the modulus operator representing an even result and a value of 1 in response to receiving a signal from the modulus operator not representing an even result, and a real component multiplier configured to multiply the increased real component by the value output by the multiplexer. In at least some embodiments, the linear approximator includes a Look-Up Table (LUT).

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. An integrated circuit comprising:
a non-linear transformation pipeline configured to perform a plurality of non-linear functions including
extracting, from an input floating point value, a fractional component and a real component,
applying, to the fractional component, a linear approximator corresponding to one non-linear function among the plurality of non-linear functions to obtain an approximate value, and
multiplying the approximate value by the real component to produce a transformed floating point value;
a memory in communication with the non-linear transformation pipeline; and
a controller configured to
transmit the input floating point value from the memory to the non-linear transformation pipeline,
configure the non-linear transformation pipeline for the one non-linear function among the plurality of non-linear functions, and
store the transformed floating point value on the memory.

2. The integrated circuit of claim 1, wherein the operations further comprise
a floating point converter configured to convert an input integer value into the input floating point value,
wherein the controller is further configured to
transmit the input integer from the memory to the floating point converter, and
transmit the input floating point value from the floating point converter to the non-linear transformation pipeline.

3. The integrated circuit of claim 1, wherein the operations further comprise
an integer converter configured to convert the transformed floating point value into a transformed integer value,
wherein the controller is further configured to
transmit the transformed floating point value from one of the non-linear transformation pipeline and the memory to the integer converter, and
store the transformed integer value on the memory.

4. The integrated circuit of claim 1, wherein the plurality of non-linear functions include an exponential function, a square root function, and an inversion function.

5. The integrated circuit of claim 4, wherein the non-linear transformation pipeline is further configured to perform one or more of a pre-extraction operation, a fractional component operation, and a real component operation.

6. The integrated circuit of claim 5, wherein
the one non-linear function is an exponential function, and
the pre-extraction operation includes multiplying the input floating point value by an approximation of an inverse of a natural log of 2.

7. The integrated circuit of claim 5, wherein
the one non-linear function is an inversion function, and
the real component operation includes inverting the real component.

8. The integrated circuit of claim 5, wherein
the one non-linear function is a square root function, and
the real component operation includes
increasing a value of the real component by 1,
determining whether the increased real component is even, and
multiplying the increased real component by the square root of 2 in response to determining that the increased real component is even.

9. The integrated circuit of claim 1, wherein the linear approximator includes a Look-Up Table (LUT).

10. An integrated circuit comprising:
a non-linear transformation pipeline including
an extractor configured to extract, from an input floating point value, a fractional component and a real component,
an approximator configured to apply, to the fractional component, a linear approximator corresponding to one non-linear function among the plurality of non-linear functions to obtain an approximate value, and
a multiplier configured to multiply the approximate value by the real component to produce a transformed floating point value;
a memory in communication with the non-linear transformation pipeline; and
a controller configured to
transmit the input floating point value from the memory to the non-linear transformation pipeline,
configure the non-linear transformation pipeline for the one non-linear function among the plurality of non-linear functions, and
store the transformed floating point value on the memory.

11. The integrated circuit of claim 10, further comprising
a floating point converter configured to convert an input integer value into the input floating point value,
wherein the controller is further configured to
transmit the input integer from the memory to the floating point converter, and
transmit the input floating point value from the floating point converter to the non-linear transformation pipeline.

12. The integrated circuit of claim 10, further comprising
an integer converter configured to convert the transformed floating point value into a transformed integer value,
wherein the controller is further configured to
transmit the transformed floating point value from one of the non-linear transformation pipeline and the memory to the integer converter, and
store the transformed integer value on the memory.

13. The integrated circuit of claim 10, wherein the plurality of non-linear functions include an exponential function, a square root function, and an inversion function.

14. The integrated circuit of claim 13, wherein the non-linear transformation pipeline further includes at least one pre-extraction transformer, at least one fractional component transformer, and at least one real component transformer.

15. The integrated circuit of claim 14, wherein
the one non-linear function is an exponential function, and
the pre-extraction transformer includes a pre-extraction multiplier configured to multiply the input floating point value by an approximation of an inverse of a natural log of 2.

16. The integrated circuit of claim 14, wherein
the one non-linear function is an inversion function, and
the real component transformer includes an invertor for inverting the real component.

17. The integrated circuit of claim 14, wherein
the one non-linear function is a square root function, and
the real component transformer includes
an adder configured to increase a value of the real component by 1,
a modulus operator configured to apply a modulus 2 operation to the increased real component,
a multiplexer configured to output a value of a square root of 2 in response to receiving a signal from the modulus operator representing an even result and a value of 1 in response to receiving a signal from the modulus operator not representing an even result, and
a real component multiplier configured to multiply the increased real component by the value output by the multiplexer.

18. The integrated circuit of claim 10, wherein the linear approximator includes a Look-Up Table (LUT).
